(19) United States
(12) Patent Application Publication
(10) Pub. No.: US 2018/0291592 A1
(43) Pub. Date: Oct. 11, 2018

(54) Apparatus and Method for Conserving Water by Diverting Water of Improper Temperature

(71) Applicant: Yuri Spiro, Beverly Hills, CA (US)

(72) Inventor: Yuri Spiro, Beverly Hills, CA (US)

(21) Appl. No.: 15/938,938

(22) Filed: Mar. 28, 2018

Related U.S. Application Data
(60) Provisional application No. 62/481,830, filed on Apr. 5, 2017.

(51) Int. Cl. E03B 7/04; F16K 31/00; E03B 1/04; G05D 23/13

(52) U.S. Cl. CPC E03B 7/045; F16K 31/002; G05D 23/1333; G05D 23/1393; E03B 1/048

(57) ABSTRACT

A water conservation apparatus that conserves water by diverting water of an undesired temperature away from the faucet and back to the hot water source for additional heating by way of a nested water pipe design.

### RELATED APPLICATIONS

This Application claims the benefit of priority under 35 U.S.C. 119(e) of Provisional Application No. 62/481,830 filed on Apr. 5, 2017. The provisional application is incorporated by reference herein in its entirety.

### BACKGROUND OF THE INVENTION

### 1. Field of the Invention

The present invention generally pertains to water preservation and more particularly to a household shower or sink water conservation apparatus that diverts initially cooled water flow that is applied from a hot water heater prior to the water becoming hot. The diverted water is returned to the hot water heater by means of a second pipe located within the water pipe connecting the hot water heater to the faucet or showerhead. The water, once warmed, is then applied into a mixture of hot and cold water flow during water usage, thus preventing needless waste of water.

### 2. Description of the Prior Art

Previously, many types of residential water conservation devices have been used to provide an effective means for saving water when showering or otherwise using water in a residence. With respect to a shower, typically, when a person is ready to shower, the hot water valve is turned on and the person waits until the shower water is hot. The person then adjusts the water mixture until the desired water temperature is achieved. The reason for the wait is that in many cases the water heater is located some distance from the shower and the water in the pipes leading to the shower has been standing, thus causing the water to cool down and to reach equilibrium with the prevailing ambient temperature. Obviously, the initial cooled water is wasted because it is drained into the sewer system.

A search of the prior art did not disclose any patents that possess the novelty of the instant invention, however the following U.S. patents are considered related:

U.S. Pat. No. 4,224,700 (Bloys) discloses a water conservation shower device that incorporates a stopper for insertion into the shower drain which includes a water pump attached to a shower head. Water accumulated in the bottom of the shower is re-circulated and reapplied through the shower head.

U.S. Pat. No. 4,854,498 (Stayton) discloses a shower temperature control system that includes a mixing valve which is connected between the hot and cold sources of water and a shower head. A gear motor shaft is connected to the mixing valve and controls the blend using a temperature sensor positioned in the shower plumbing.

U.S. Pat. No. 4,854,499 (Newman) discloses a temperature sensitive shower diverter valve for diverting shower water used between the water source and the shower head.

U.S. Pat. No. 5,277,218 (Sanchez) discloses a water delivery conduit operative through a valve member which directs water from a shower conduit to a storage tank. The storage tank permits selective use of water from a primary conduit or from the delivery conduit for the utilization of water therefrom.

U.S. Pat. No. 5,285,537 (Hanks) discloses an apparatus that includes a pickup head mounted to a shower drain, which is operative through a storage tank for pressurized flow to an auxiliary shower head.

U.S. Pat. No. 5,689,543 (Duke) discloses a water conservation system for a shower. The system utilizes a foot operated control valve piped to a T-spigot that is connected to the shower head, thereby reducing the water flow by usage only when required.

### SUMMARY OF THE INVENTION

The present invention is designed to conserve shower or sink water during the initial water-flow interval when the cooled water is being heated. In its basic configuration the invention is comprised of a water conservation apparatus that directs water that has not yet been heated to optimum temperature back to the hot water source for further heating by means of a nested pipe configuration. The nested pipe configuration comprises a first inner pipe configured to permit water flow of initially cool water from a hot water source to a water diversion and reservoir assembly and a second outer pipe allowing cool water to flow from the water diversion and reservoir assembly back to the hot water source. The water diversion and reservoir assembly includes: (1) a means for diverting the water flow from the hot water source back to the hot water source through the second outer pipe for further heating; (2) a means to measure the temperature of the water flowing from the inner pipe into the reservoir assembly; (3) a means for permitting water flow from the cold water source to flow into the water diversion and reservoir assembly (4) a means for preventing water flow through the second pipe to the hot water source once the water in the diversion and reservoir assembly has reached a desired temperature; and (5) a means for the water contained in the diversion and reservoir assembly to flow to the faucet, e.g., to the shower head or faucet to the user.

In view of the above disclosure, the primary object of the invention is to conserve water by utilizing a nested pipe assembly comprising an inner and outer pipe that stops water of an undesired temperature from leaving the shower head or faucet and returns it to the hot water heater using the outer piping of the nested pipe assembly. The cold water is re-circulated and heated before the water flows again through the inner pipe of the nested pipe assembly. When the desired temperature is reached, the heated water is then allowed to flow to and mix with the water flowing from the cold water source for final temperature refinement and then to the shower head or faucet.

Another object of the invention is to provide a means for assisting in the insulation of water contained within a water pipe by configuring the water pipe in a manner that provides for the flow of water in a second nested water pipe, thus preventing heat loss from the water flowing in the first pipe.

It is also an object of the invention to provide a system that utilizes a simple type of fabrication, as all of the elements that are used to assemble the invention are well known in the art and are easily procured, utilizes plumbing that is easily installed in existing showers and simple modifications can be made to the piping where separate hot and cold water pipes are already employed, is easily installed in new buildings, as the piping is simple and straightforward, is dependable as little or no maintenance is required, and is cost effective from both a manufacture's and consumer's points of view.

These and other objects and advantages of the present invention will become apparent from the subsequent detailed description of the preferred embodiment in conjunction with the accompanying drawings.

### BRIEF DESCRIPTION OF THE DRAWINGS

FIG. 1 is a schematic diagram of the elements that comprise the invention

FIG. 2 is a cross-sectional perspective view of the nested pipe arrangement of the invention.

FIG. 3 is a schematic showing the method of diverting water movement through the nested pipe assembly of the invention.

FIG. 4 is an exploded cross-sectional partial view of the invention showing the components of the diversion assembly of a preferred embodiment the invention.

FIG. 5 is an exploded, cross-sectional partial view of an embodiment of the invention showing the components of the diversion assembly and the showing the temperature sensitive directing means in its “open” position.

FIG. 6 is an exploded cross-sectional perspective partial view of an embodiment of the present invention showing the components of the base assembly.

FIG. 7 is an exploded, cross-sectional perspective partial view of another embodiment of the invention showing components of the base assembly.

### DETAILED DESCRIPTION OF THE INVENTION

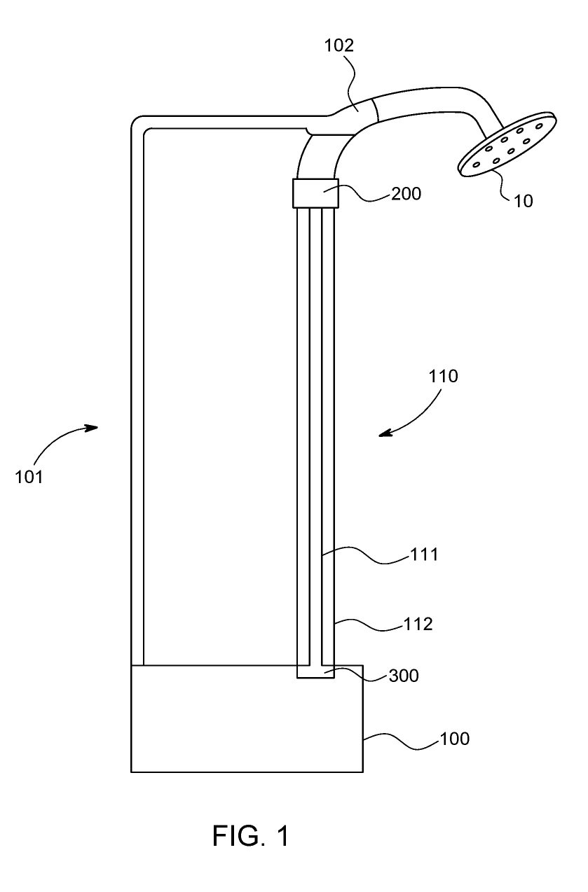

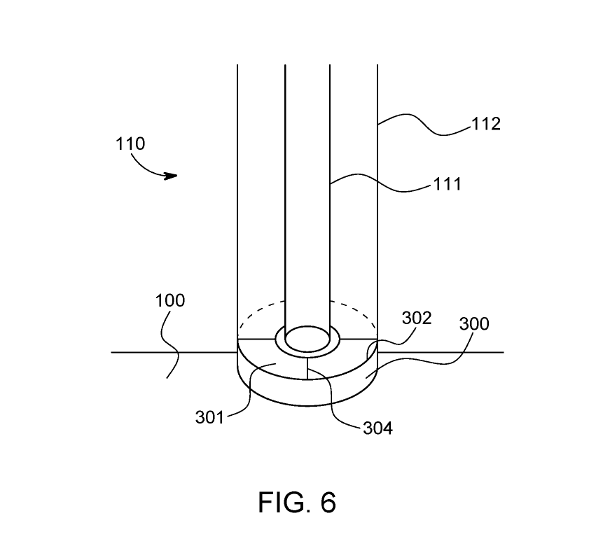

Referring to FIG. 1, the preferred embodiment of the invention comprises a nested pipe assembly (110) comprising an inner pipe (111) and an outer pipe (112). The nested pipe assembly is connected at one end to a hot water source via a base assembly (300) and at the other end to a diversion assembly (200). In the embodiment shown in FIG. 1, the base assembly (300) is mounted flush with the hot water source (100). However, it is understood that in other embodiments the base assembly (300) can be positioned outside the hot water source (100), in which case, the base assembly would preferably be connected to the hot water source by traditional plumbing means, for example, by piping. An example of this is shown in FIG. 6, which shows a nested pipe assembly (110) configured for use with a tankless water heating system of the type commonly found in the art. Alternatively, the base assembly (300) can be positioned inside or otherwise be integral with the hot water source (100).

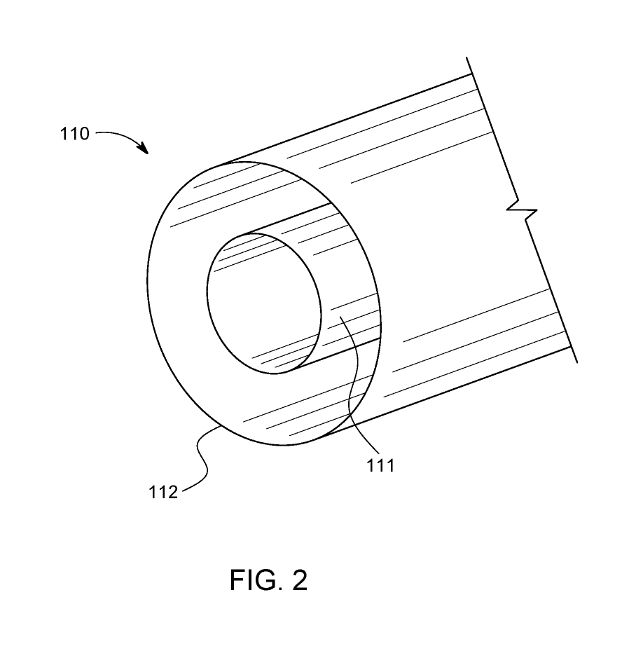

FIG. 2 shows a segment of the nested pipe assembly (110) comprising the inner pipe (111) and outer pipe (112) in a preferred embodiment of the invention.

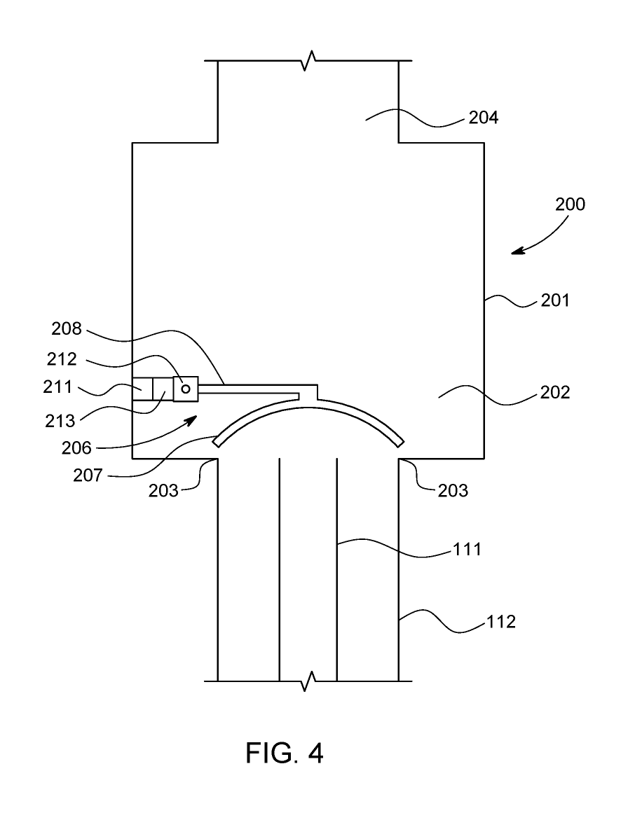

As can be seen in FIG. 1, in a preferred embodiment, the diversion and reservoir assembly (200) is connected to a traditional shower valve assembly (102), which is a pressure balancing shower valve or thermostatic shower valve traditionally found in the art, which in turn is connected to the shower head (10) of the types typically found in the art. Referring to FIG. 4, a preferred embodiment of the invention provides for a diversion assembly (200) that includes a housing (201) which defines an internal cavity (202), an inlet port (203) adapted to be connected to the nested pipe assembly (110), an outlet port (204) for connection to a faucet. A directing means (206) directs the water entering the inlet port (203) from the inner pipe (111) to the outer pipe (112) when the temperature of the water is outside a pre-selected range. The directing means (206) comprises a valve element (207) and a rotatable stein (208) with a proximal end secured to the housing (201) and a distal end secured to the valve element (207). Operation of the directing means is accomplished, in a preferred embodiment, by means of a temperature sensor (211) for measuring the temperature of the water, an actuator means (212) for rotating the stein (208) and a controller means (213) for controlling the actuator means (212) according to the temperature of the water measured by the temperature sensor (211). The temperature sensor (211) may be either a thermistor or a variable resistor. Both are capable of translating temperature into an electronic parameter such as voltage. The actuator means (212) is a solenoid that pushes or pulls to rotate the rotatable stein (208).

The controller means (213) is a microprocessor which can be understood to be connected to a temperature display or control panel for use by the user and will provide a temperature adjustment means for the bather to enter water temperature figures to create a water temperature range which is acceptable. The temperature display would indicate to the user the present temperature at the temperature sensor (211) allowing the bather to better determine the desired level.

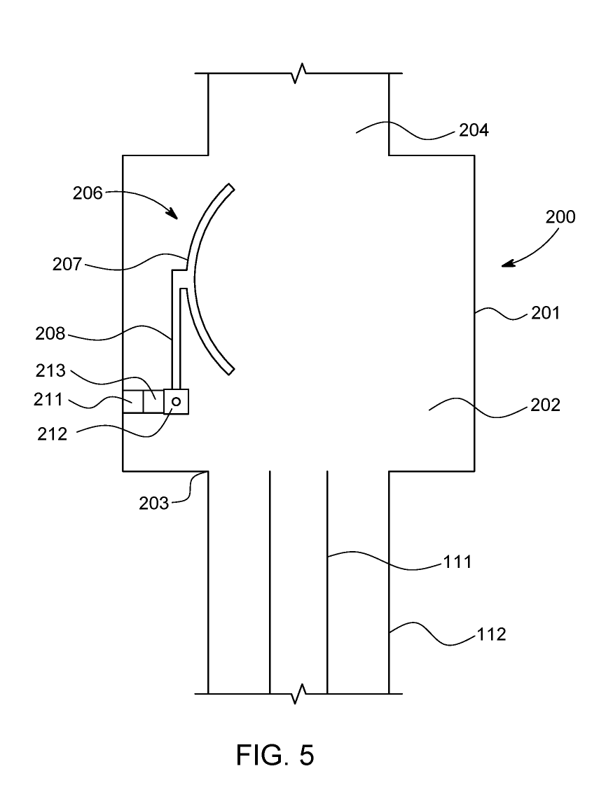

As illustrated in FIG. 5, when the temperature of the water is within the pre-selected range the temperature sensitive directing means (206) “opens” and thus directs the water from the inner pipe (111) to the outlet port (204) and then on to the faucet. FIG. 5 shows the diversion and reservoir assembly (200) with the temperature sensitive directing means (206) in this “open” position.

It is understood that power for the operation of the director means and its components is provided by a battery or other suitable power source known in the art. It will be appreciated that line electrical power may also be utilized.

As can be seen in FIG. 6, a base assembly (300) connects the nested pipe assembly (110) to the Hot Water Source (100). The base assembly comprises a bracing means (301) to stabilize the inner pipe which is defined by a concentric outer ring (302) connected along its diameter by one or more connectors (304) and wherein the outer ring (302) threadably secures the outer pipe (112) to the base assembly (300).

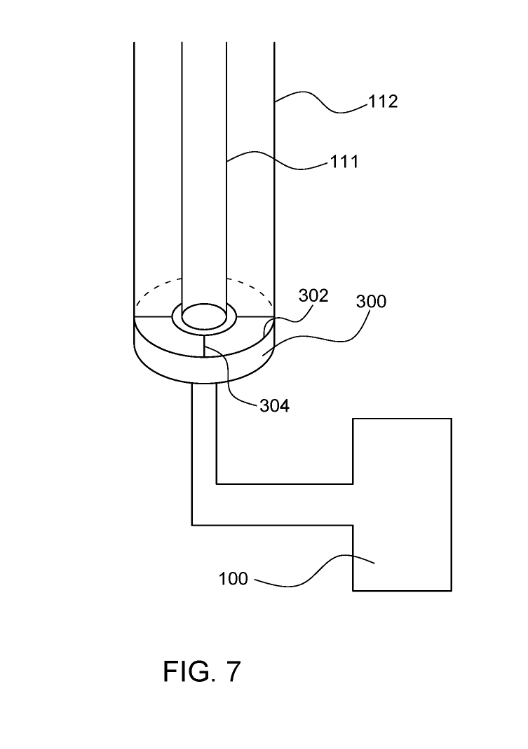

While FIG. 6 shows the base assembly (300) connected flush to the hot water source (100), it is understood that the base assembly can be positioned externally to the hot water source (100) and simply connected to the hot water source (100) by means of piping that runs from the base assembly to the hot water source (100). FIG. 7 shows such an arrangement and which may be preferable where the hot water source is of the tank-less variety found in the art.

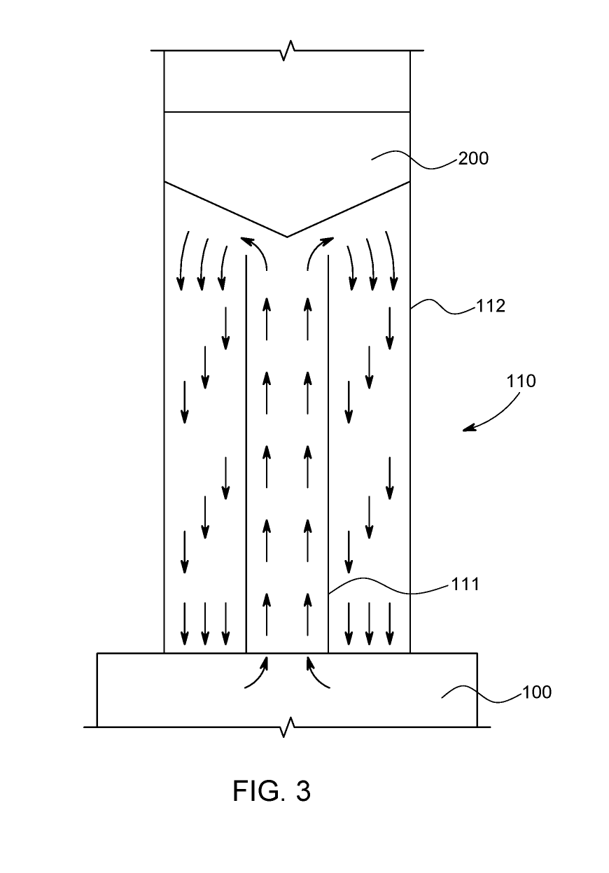

As shown in FIG. 3, the method of the present invention is illustrated as water moving through the inner piper (111) to the diversion and reservoir assembly (200). Upon arriving at the diversion and reservoir assembly (200), water not of the pre-selected temperature will be diverted back to the hot water source (100) by the directing means (206) via the outer pipe (112).

In view of the above, it is understood that the movement of water from the inner pipe (111) to the outer pipe (112) and back to the hot water source (100) also provides an insulating benefit to the water flowing through the inner pipe (111). It is also understood that by a user selecting a desired temperature, water flow, through pressure originating from the hot water source (100), can permit the flow of water from the inner pipe (111), water that under normal circumstances would be standing, and thus cooling, during periods of non-use. By virtue of the water being forced back to the hot water source (100) for additional heating, even during periods of non-use, a more instantaneous access to water of a desired temperature is achieved.

It is understood that the structure and method described above may be variously implemented and variously used depending upon specific applications. Accordingly, the scope hereof shall not be referenced to the disclosed embodiments, but on the contrary, shall be determined in accordance with the general definitions assigned to the terms herein.

1. A water conservation system comprising: a nested pipe assembly comprising an outer pipe and an inner pipe secured within the outer pipe; a base assembly secured to one end of the nested pipe assembly and comprising an attachment means to secure the nested pipe assembly to a hot water source; a diversion chamber secured to the other end of the nested pipe assembly and comprising an inlet port to permit entry of water from the inner pipe into the diversion chamber, an outlet port with attachment means to permit flow of water from the diversion chamber to a faucet; a directing means secured to the diversion chamber and configured to direct water entering the diversion chamber from the inner pipe to either the outer pipe for return to the hot water source or to the outlet port of the nested pipe assembly depending on the temperature of said water, with said directing means comprising a valve, a temperature sensor, and an actuator means for opening and closing the valve; and a control means in electronic communication with the temperature sensor and actuator means of the directing means with said control means comprising a power source, a user operated temperature setting function and an input and display panel.

2. A water conversation system of claim 1 wherein the base assembly further comprises a bracing means to support the inner pipe of the nested pipe assembly.

3. A water conservation system of claim 1 wherein the power source of the control means is a battery.

4. A water conservation system of claim 1 wherein the temperature sensor is a thermistor.

5. A water conversation system of claim 1 wherein the diversion chamber further comprises a mixing valve.

6. A water conservation system of claim 1 wherein the outlet port of the diversion chamber is attached to a shower valve assembly.

7. A method for conserving water comprising the steps of securing nested pipes comprising an inner pipe and outer pipe to a hot water source, directing water from the hot water source through the inner pipe to a diversion chamber, measuring the temperature of the water entering the diversion chamber, redirecting water of an undesired temperature through the outer pipe back to the hot water source for further heating; and allowing water of a desired temperature to exit the diversion chamber to a faucet for use.

8. The method of claim 7 comprising the further step of selecting a desired temperature of water to allow through to the faucet.
